(19) United States
(12) Patent Application Publication
(10) Pub. No.: US 2006/0214588 A1
(43) Pub. Date: Sep. 28, 2006

(54) High-pressure discharge lamp

(75) Inventors: Ulrich Henger, Eichenau (DE); Andreas Kloss, Neubiberg (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/386,814

(22) Filed: Mar. 23, 2006

(30) Foreign Application Priority Data
Mar. 24, 2005 (DE) 102005013897.7

(51) Int. Cl. H01J 61/04

(52) U.S. Cl. 313/631; 313/623

(57) ABSTRACT

The discharge lamp is held axially in an outer bulb. That end of the outer bulb which is remote from the cap is configured in such a way that it avoids the standard radially symmetrical convex shape. This substantially prevents reflection back onto the discharge vessel.

### TECHNICAL FIELD

The invention is based on a high-pressure discharge lamp, having a discharge vessel which is arranged axially in an outer bulb, has two seals and is equipped with an outer bulb, which is capped on one side. It deals in particular with the field of metal halide lamps, high-pressure sodium lamps or high-pressure mercury lamps.

### BACKGROUND ART

U.S. Pat. No. 5,493,168 has disclosed a lamp in which a discharge vessel is surrounded by an outer bulb. The discharge vessel is sealed on two sides, and the outer bulb is capped on one side. With lamps of this type, it has been found that the lamps are subject to high thermal stress, since the convex dome reflects back the radiation emitted from the discharge vessel. This imposes particularly high stresses on the dome-side seal. This is true in particular of lamps with ceramic discharge vessels, with which a high level of corrosion has been recorded in the region of the soldering glass in the capillary. This leads to a high rate of premature failures. Such failures are particularly critical because the failure takes place in operation, i.e. when the lamp is hot.

### DISCLOSURE OF THE INVENTION

It is an object of the present invention to provide a high-pressure discharge lamp, having a discharge vessel which is arranged axially in an outer bulb, has two seals and is equipped with an outer bulb, which is capped on one side, which is subject to reduced thermal stresses and therefore has a longer service life.

This object is achieved by the following features: the end of the outer bulb which is remote from the cap is configured in such a way that it reflects less radiation, in particular at least 50% less radiation, onto the discharge vessel, in particular onto the seal remote from the cap, compared to a convex, domed-shaped end of the outer bulb remote from the cap.

Particularly advantageous configurations are given in the dependent claims.

In principle, the high-pressure discharge lamp according to the invention has a discharge vessel which is arranged axially in an outer bulb, has two seals and is equipped with an outer bulb, which is capped on one side. That end of the outer bulb which is remote from the cap is configured in such a way that it reflects at least 50% less radiation onto the discharge vessel compared to a convex, radially symmetrically configured end of the outer bulb.

In particular, the end remote from the cap may be planar or prismatic in form. An alternative is for the end remote from the cap to be beveled on one side.

Another alternative is for the end remote from the cap to have an eccentric tip which is located at least 10%, preferably at least 15%, of the radius of the outer bulb away from the center. In this case, the end remote from the cap may be asymmetrically beveled. In another embodiment, the wall is curved concavely at the end which leads to the tip.

Another alternative is for the end remote from the cap to be curved concavely in its entirety.

This concept gives rise to particular benefits if the discharge vessel is made from ceramic and in particular has capillaries which are sealed with soldering glass, since in this case the additional thermal stresses which occur with the conventional form of the end remote from the cap are particularly critical. In general, this leads to increased stressing of the capillary remote from the cap amounting to from 20 to 40 K. The concept according to the invention makes it possible to either completely eliminate the increased stresses or at least restrict them to less than 10 K.

The invention is of particular worth for metal halide lamps in which the ingredients, predominantly metal halides, are aggressive with respect to the soldering glass. In particular rare earths, such as Tm, are particularly aggressive and effectively attack the soldering glass. Therefore, minimized thermal stressing in the region of the seal plays a crucial role in achieving a good service life.

These are in particular fill systems for neutral-white and daylight-like luminous colors. These fill systems often include iodides of the rare earths, such as Dy, Ho, Tm and often also Cs and Tl as well as Hg and a starting gas, such as Ar. In particular fill systems comprising rare earths have a considerable influence on the service life. Therefore, the configuration according to the invention applies in particular to fills which contain a considerable amount of halides, in particular iodides and bromides, of the rare earths, in particular in a proportion of at least 30 mol % of the total metal halide fill.

The outer bulb is usually made from hard glass, such a aluminoborosilicate glass. It is preferable for at least part of the outer bulb to be provided with a reflection-reducing layer, preferably a dichroic layer.

Designs in which the overall height of the lamp is not increased, i.e. planar and concave shapes of that end of the outer bulb which is remote from the cap, are particularly preferred.

### BRIEF DESCRIPTION OF THE DRAWINGS

The invention is to be explained in more detail below on the basis of a number of exemplary embodiments. In the drawing:

FIG. 1 shows a side view of a metal halide lamp;

FIG. 2 shows the design in accordance with the prior art;

FIGS. 3 to 6 show side views of further exemplary embodiments of the outer bulb;

FIG. 7 shows a comparison of the temperatures at the discharge vessel with and without reflection avoidance.

### BEST MODE FOR CARRYING OUT THE DRAWING

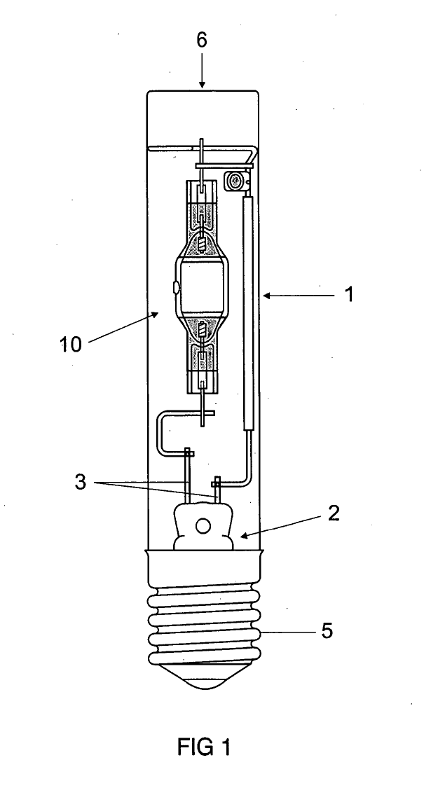

FIG. 1 shows a metal halide lamp having an outer bulb 1 made from hard glass or quartz glass, which has a longitudinal axis and is closed on one side by a fused plate seal 2. Two supply conductors 3 lead out (partially not visible) through the fused plate seal 2. They end in a cap 5. A discharge vessel 10 which is pinched on two sides, is made from quartz glass and has a fill of metal halides, is arranged axially in the outer bulb. The outer bulb 1 comprises a cylindrical tube, of which the end 6 remote from the cap is planar in form, at least over 90% of its surface. A pump tip is not ruled out but should preferably be positioned eccentrically.

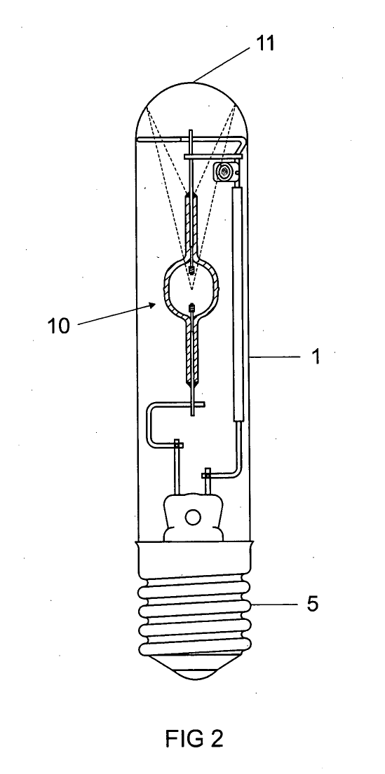

FIG. 2 shows the prior art used hitherto, in which the end remote from the cap was shaped as a convex dome 11. Hitherto, no particular attention was paid to this shape. However, the rays which pass from the discharge vessel, in this case a ceramic discharge vessel, in parallel to the end remote from the cap—two of these rays are indicated in the drawing—are reflected back onto the seal, which is in this case designed as a capilliary.

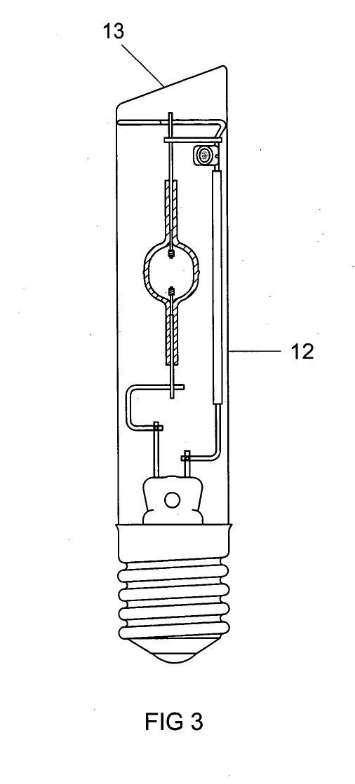

FIG. 3 shows an outer bulb 12 whereof the end 13 remote from the cap is beveled on one side, as in the case of a prism.

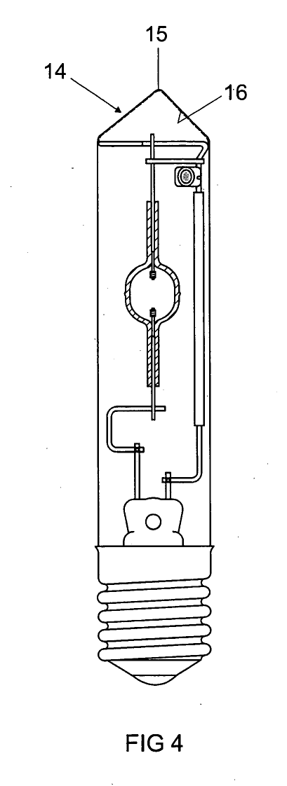

FIG. 4 shows an end 14 remote from the cap which does have a tip 15. However, the tip is eccentric, preferably arranged at a distance of at least 15% of the radius of the outer bulb from the center axis. The wall of the end remote from the cap which leads to the tip is beveled in a straight line, resembling an asymmetrically built teepee. It is coated with a reflection-reducing dichroic layer 16.

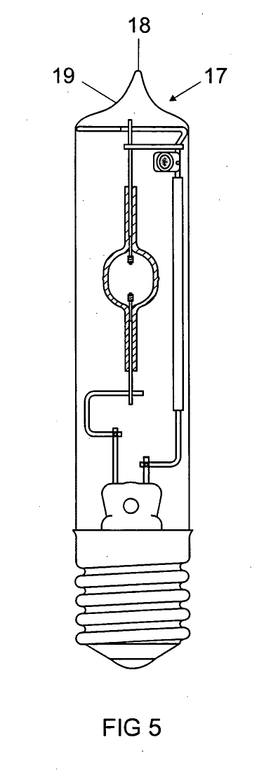

FIG. 5 shows an end 17 remote from the cap which likewise has a tip 18. In this case too, the tip 18 is eccentric, with the wall 19 leading to the tip in this case being of concave configuration in its entirety.

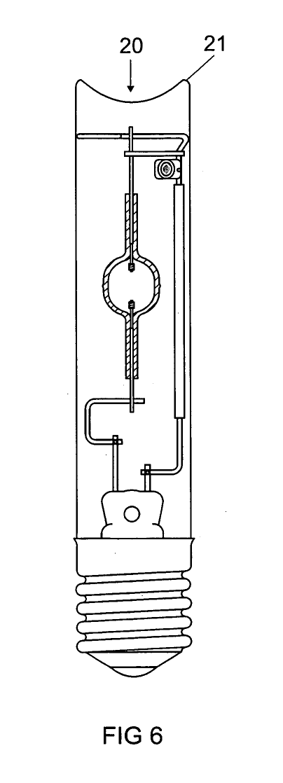

FIG. 6 shows an exemplary embodiment in which the end 20 remote from the cap is itself shaped so as to be concave, preferably radially symmetrically concave, in its entirety. This results in the formation of a peripheral wall 21. This shape has the lowest overall height, together with the planar shape.

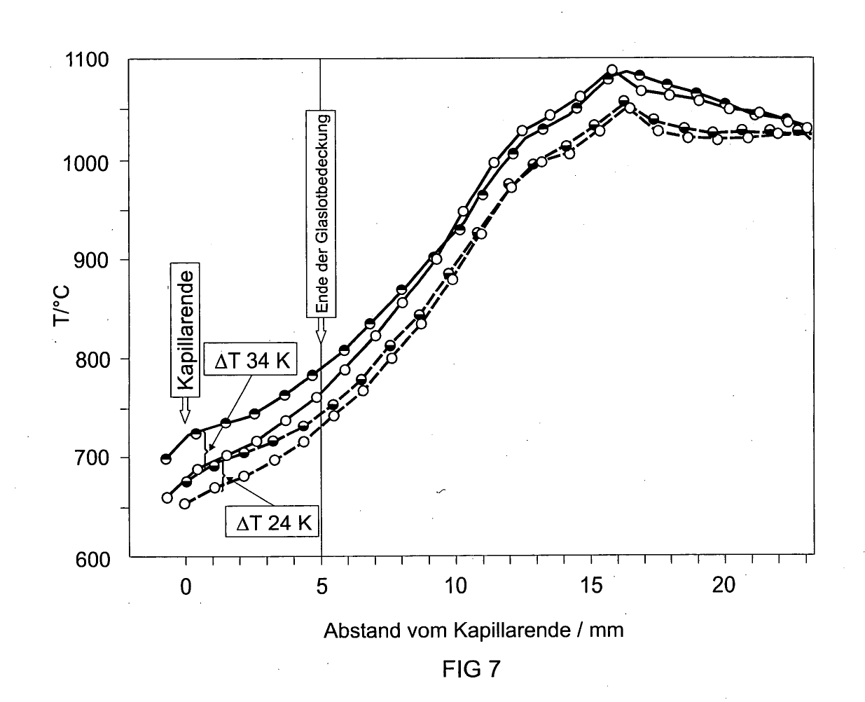

FIG. 7 shows a measurement of the thermal stressing in lamps with a conventional dome and with a planar end remote from the cap. The comparison reveals a stronger effect with a standing operating position (solid lines), since in this case the thermal stressing of the end remote from the cap through convection is higher, whereas the action is only about ⅔ of the level of this action in the case of a suspended operating position (dashed curves). The figure illustrates the temperature at the capillary end, continuing in the direction toward the discharge vessel. Of course, the closer one is to the discharge vessel itself, the smaller the temperature difference becomes. However, it is precisely the zone at the end of the capillary which is the zone where the soldering glass effects sealing. In the specific case, it is 5 mm, cf. the straight line indicated in the drawing. It is precisely here that the invention comes to bear. It lowers the thermal stressing at the capillary end remote from the cap by approximately 30 K in the case of a standing operating position and by approximately 20 K in the case of a suspended operating position.

Ultimately, in the case of a metal halide lamp with a neutral-white luminous color, this lengthens the service life by more reliably avoiding premature failures caused by capillaries developing leaks.

The term soldering glass used here is to be understood as meaning all types of sealing material, in particular for example including materials such as fusible ceramics.

One significant aspect of the invention is that that end of the outer bulb which is remote from the cap is configured in such a way that it reflects less radiation, in particular at least 50% less radiation, onto the discharge vessel, in particular onto the seal remote from the cap, compared to a convex, dome-shaped end of the outer bulb remote from the cap.

What is claimed is:

1. A high-pressure discharge lamp having a discharge vessel which is arranged axially in an outer bulb, has two seals and is equipped with an outer bulb, which is capped on one side, wherein that end of the outer bulb which is remote from the cap is configured in such a way that it reflects less radiation, in particular at least 50% less radiation, onto the discharge vessel, in particular onto the seal remote from the cap, compared to a convex, domed-shaped end of the outer bulb remote from the cap.

2. The lamp as claimed in claim 1, wherein the end remote from the cap is planar or prismatic in form.

3. The lamp as claimed in claim 1, wherein the end remote from the cap is beveled on one side.

4. The lamp as claimed in claim 1, wherein the end remote from the cap has an eccentric tip which is located at least 10%, preferably at least 15%, of the radius of the outer bulb away from the center.

5. The lamp as claimed in claim 4, wherein the end remote from the cap is asymmetrically beveled.

6. The lamp as claimed in claim 4, wherein the wall is curved concavely at the end which leads to the tip.

7. The lamp as claimed in claim 1, wherein the end remote from the cap is curved concavely in its entirety.

8. The lamp as claimed in claim 1, wherein the discharge vessel is made from ceramic and in particular has capillaries sealed with soldering glass.

9. The lamp as claimed in claim 1, wherein the fill in the discharge vessel includes rare earths as a constituent of the metal halide fill.

10. The lamp as claimed in claim 1, wherein part of the outer bulb is provided with a reflection-reducing layer.
